(19) United States
(12) Patent Application Publication
(10) Pub. No.: US 2016/0203514 A1
(43) Pub. Date: Jul. 14, 2016

(54) SYSTEM FOR IMPROVING VISIBILITY OF WEBPAGES OF RETAIL STORES IN ONLINE SEARCHES

(71) Applicant: NOWFLOATS TECHNOLOGIES PVT. LTD., Telangana State (IN)

(72) Inventor: Ronak Kumar Samantray, Hyderabad (IN)

(21) Appl. No.: 14/915,993

(22) PCT Filed: Sep. 2, 2014
(86) PCT No.: PCT/IN2014/000573

§ 371 Date: Mar. 2, 2016

(30) Foreign Application Priority Data
Sep. 2, 2013 (IN) 3923/CHE/2013

(51) Int. Cl. G06Q 30/02; G06F 17/22; G06F 17/30

(52) U.S. Cl. CPC G06Q 30/0256; G06Q 30/0259; G06F 17/30899; G06F 17/3089; G06F 17/2247

(57) ABSTRACT

A system for improving visibility of one or more webpages of one or more retail stores in online searches is provided. The system includes one or more client devices associated with the retail stores, and a data processing arrangement coupled in communication with the client devices. The data processing arrangement is operable to receive one or more store-specific messages from a given client device associated with a given retail store, and is then operable to process the store-specific messages to create and/or update a given webpage of the given retail store. Moreover, the data processing arrangement is operable to parse the store-specific messages to extract one or more keywords, and is operable to provide the keywords in the given webpage. This enables keyword-based searching of the given webpage of the given retail store in the online searches.

### CROSS-REFERENCE TO RELATED APPLICATION(S)

This application is a patent-of-addition of Indian patent application no. 1326/CHE/2012 entitled “SYSTEM AND METHOD FOR CREATING WEBSITE” dated Apr. 2, 2012 claiming priority from the same and incorporated by reference in its entirety.

### FIELD OF THE INVENTION

The present invention generally relates to creating and/or updating webpages, and more specifically, to systems for improving visibility of one or more webpages of one or more retail stores in online searches. Further, the present invention relates to methods of operating the systems for improving the visibility of the webpages of the retail stores in the online searches. Furthermore, the present invention also relates to software products recorded on non-transitory machine-readable data storage media, wherein the software products are executable upon computing hardware to implement the aforesaid methods.

### BACKGROUND OF THE INVENTION

Today, when a customer wishes to buy a particular product offered by a particular brand, he/she may try to search for information related to that particular product, for example, using an online search engine, such as Google. Apart from information about features, reviews and/or prices of the particular product, the customer may be interested in knowing about brick-and-mortar retail stores from where he/she may purchase that particular product.

In order to provide information that is more relevant to the customer, the online search engine typically organizes its search results with respect to a geographical location that could be of interest to the customer. The geographical location may, for example, be determined from at least one of:

(a) an Internet Protocol (IP) address of a computing device from which the customer may have performed an online search,

(b) a Global Positioning System (GPS) sensor of a smart phone from which the customer may have performed the online search, and/or

(c) a name of a place provided by the customer in a search query itself.

Furthermore, in an attempt to search for retail stores of the particular brand in a particular geographical location, such as a city or a region in the city, the customer may use a search query that includes a name of that particular geographical location, for example, such as “Nokia Lumia in Hyderabad”. Today, search results of such location-based search queries typically provide links to:

(a) websites of online stores, such as Flipkart, and/or

(b) websites of online classifieds, such as OLX and Quikr.

However, these search results do not provide information about retail stores of the particular brand. Therefore, in order to search for retail stores of that particular brand, the customer has to specifically use a search query that includes a name of the particular brand and the term “store”, for example, such as “Nokia stores”. Today, search results to such search queries typically provide links to:

(a) a “store locator” webpage provided by a website of the particular brand, and/or

(b) webpages that show the retail stores on maps.

However, such “store locator” webpages of brands often provide only contact details of retail stores, for example, including addresses and phone numbers of the retail stores. The “store locator” webpages do not provide any information about products and/or offers that are available in these retail stores.

In light of the foregoing discussion, there exists a need for a system for improving visibility of one or more webpages of one or more retail stores in online searches.

### SUMMARY OF THE INVENTION

The present invention seeks to provide a system for improving visibility of one or more webpages of one or more retail stores in online searches.

The present invention also seeks to provide a method of operating the system for improving the visibility of the webpages of the retail stores in the online searches.

In one aspect, embodiments of the present invention provide a system for improving visibility of one or more webpages of one or more retail stores in online searches. The system includes one or more client devices associated with the retail stores, and a data processing arrangement coupled in communication with the client devices.

Users use the client devices to provide the data processing arrangement with inputs for creating and/or updating the webpages of the retail stores. These inputs may be provided in a form of one or more messages that may, for example, include information pertaining to content to be displayed on the webpages. Upon receiving the inputs, the data processing arrangement creates and/or updates the webpages of the retail stores.

A given user responsible for creating and/or updating a given webpage of a given retail store uses a given client device to send one or more store-specific messages to the data processing arrangement. The store-specific messages may, for example, include information pertaining to at least one of: a name of the given retail store, a geographical location of the given retail store, an address of the given retail store, a phone number of the given retail store, an email address of the given retail store, timings of the given retail store, one or more businesses of the given retail store, one or more user-specified keywords for the given webpage, one or more photographs of the given retail store, directions within a map, one or more products offered by the given retail store, prices of one or more products, one or more deals provided by the given retail store, a marketing campaign occurring in the given retail store, a discount campaign occurring in the given retail store, one or more status updates, and/or one or more tips that may be of interest to visitors.

Upon receiving the store-specific messages, the data processing arrangement is operable to process the store-specific messages to create and/or update the given webpage of the given retail store. Beneficially, the given webpage may be created and/or updated on a real-time basis. In this manner, the data processing arrangement is operable to create and/or update the given webpage in a dynamic manner.

Additionally, the data processing arrangement is operable to parse the store-specific messages to extract one or more keywords. Beneficially, the store-specific messages may be parsed semantically.

Thereafter, the data processing arrangement is operable to provide the keywords in the given webpage of the given retail store. For example, the keywords may be provided in content and/or metadata of the given webpage of the given retail store. This enables keyword-based searching of the given webpage of the given retail store in the online searches, and in turn, improves visibility of the given webpage in the online searches.

Beneficially, at least one of the keywords may pertain to a geographical location of the given retail store. This may enable location-based searching of the given webpage of the given retail store in the online searches. This may further improve the visibility of the given webpage in the online searches.

Moreover, the data processing arrangement may be operable to classify the store-specific messages into a plurality of classifications depending on similarities between the keywords and/or time periods between which the store-specific messages were received by the data processing arrangement.

Moreover, the data processing arrangement may be operable to update one or more existing features of the given webpage and/or add one or more new features to the given webpage, based on most recent store-specific messages.

Moreover, the data processing arrangement may be operable to send one or more notifications to the given client device about recent visits made to the given webpage.

Moreover, the system may also include a managerial client device coupled in communication with the data processing arrangement. The data processing arrangement may be operable to receive from the managerial client device one or more messages mutually pertaining to some or all of the retail stores. The data processing arrangement may then be operable to analyze these messages to update one or more webpages corresponding to these retail stores.

Furthermore, the data processing arrangement may be operable to gather information pertaining to at least one of:

(a) products searched for in the online searches, and/or

(b) geographical locations of visitors who performed the online searches to visit one or more webpages corresponding to the retail stores.

Subsequently, the data processing arrangement may be operable to analyze the gathered information to determine at least one of:

(a) one or more products that have a high demand in a given geographical location, and/or

(b) one or more geographical locations where there is a high demand for a given product.

In this manner, the data processing arrangement may be operable to correlate inventories of the retail stores with location-based demands of the online searches.

In another aspect, embodiments of the present invention provide a method of operating the system for improving the visibility of the webpages of the retail stores in the online searches.

In yet another aspect, embodiments of the present invention provide a software product recorded on non-transitory machine-readable data storage media, wherein the software product is executable upon computing hardware for implementing the method of operating the system for improving the visibility of the webpages of the retail stores in the online searches.

Embodiments of the present invention substantially eliminate the aforementioned problems in the prior art, and enable users to create and/or update webpages of their respective retail stores easily, and to provide latest information on the webpages in real time, thereby improving visibility of the webpages in online searches; help visitors find information that is relevant to their online searches; enable store managers to manage inventories of their respective retail stores depending on location-based demands of the online searches; and/or enable brand managers to identify one or more geographical locations where businesses of their brands are likely to be profitable.

Additional aspects, advantages, features and objects of the present invention would be made apparent from the drawings and the detailed description of the illustrative embodiments construed in conjunction with the appended claims that follow.

It will be appreciated that features of the present invention are susceptible to being combined in various combinations without departing from the scope of the present invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present invention, exemplary constructions of the disclosure are shown in the drawings. However, the present invention is not limited to specific methods and instrumentalities disclosed herein. Moreover, those in the art will understand that the drawings are not to scale. Wherever possible, like elements have been indicated by identical numbers.

Embodiments of the present invention will now be described, by way of example only, with reference to the following diagrams wherein:

FIG. 1 is a schematic illustration of a system for improving visibility of one or more webpages of one or more retail stores in online searches, in accordance with an embodiment of the present invention;

FIG. 2 is a schematic illustration of various components in an example implementation of a data processing arrangement, in accordance with an embodiment of the present invention; and

FIG. 3 is an illustration of steps of a method of operating the system for improving the visibility of the webpages of the retail stores in the online searches, in accordance with an embodiment of the present invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS OF THE INVENTION

The following detailed description illustrates embodiments of the present invention and ways in which it can be implemented. Although the best mode of carrying out the present invention has been disclosed, those in the art would recognize that other embodiments for carrying out or practicing the present invention are also possible.

Embodiments of the present invention provide a system for improving visibility of one or more webpages of one or more retail stores in online searches. The system includes one or more client devices associated with the retail stores, and a data processing arrangement coupled in communication with the client devices.

Users use the client devices to provide the data processing arrangement with inputs for creating and/or updating the webpages of the retail stores. These inputs may be provided in a form of one or more messages that may, for example, include information pertaining to content to be displayed on the webpages. Upon receiving the inputs, the data processing arrangement creates and/or updates the webpages of the retail stores.

For illustration purposes only, let us consider an example scenario in which a given user is responsible for creating and/or updating a given webpage of a given retail store. The given user uses a given client device associated with the given retail store to send one or more store-specific messages to the data processing arrangement.

The term “store-specific messages” may refer to one or more messages specific to the given retail store. For example, the store-specific messages may include information pertaining to at least one of: a name of the given retail store, a geographical location of the given retail store, an address of the given retail store, a phone number of the given retail store, an email address of the given retail store, timings of the given retail store, one or more businesses of the given retail store, one or more user-specified keywords for the given webpage, one or more photographs of the given retail store, directions within a map, one or more products offered by the given retail store, prices of one or more products, one or more deals provided by the given retail store, a marketing campaign occurring in the given retail store, a discount campaign occurring in the given retail store, one or more status updates, and/or one or more tips that may be of interest to visitors.

The term “product” may refer to various products and services provided by various retail stores, while the term “retail store” may refer to retail stores, service stores, and the like, throughout the present disclosure.

Upon receiving the store-specific messages, the data processing arrangement is operable to process the store-specific messages to create and/or update the given webpage of the given retail store. Beneficially, the given webpage may be created and/or updated on a real-time basis. In this manner, the data processing arrangement is operable to create and/or update the given webpage in a dynamic manner.

Additionally, the data processing arrangement is operable to parse the store-specific messages to extract one or more keywords. Beneficially, the store-specific messages may be parsed semantically.

Thereafter, the data processing arrangement is operable to provide the keywords in the given webpage of the given retail store. For example, the keywords may be provided in content and/or metadata of the given webpage of the given retail store. This enables keyword-based searching of the given webpage of the given retail store in the online searches, and in turn, improves visibility of the given webpage in the online searches.

Beneficially, at least one of the keywords may pertain to a geographical location of the given retail store. This may enable location-based searching of the given webpage of the given retail store in the online searches. This may further improve the visibility of the given webpage in the online searches.

Moreover, the data processing arrangement may be operable to classify the store-specific messages into a plurality of classifications depending on similarities between the keywords and/or time periods between which the store-specific messages were received by the data processing arrangement.

Moreover, the data processing arrangement may be operable to update one or more existing features of the given webpage and/or add one or more new features to the given webpage, based on most recent store-specific messages.

Moreover, the data processing arrangement may be operable to send one or more notifications to the given client device about recent visits made to the given webpage.

Moreover, the system may also include a managerial client device coupled in communication with the data processing arrangement. The data processing arrangement may be operable to receive from the managerial client device one or more messages mutually pertaining to some or all of the retail stores. The data processing arrangement may then be operable to analyze these messages to update one or more webpages corresponding to these retail stores.

Furthermore, the data processing arrangement may be operable to gather information pertaining to at least one of:

(a) products searched for in the online searches, and/or

(b) geographical locations of visitors who performed the online searches to visit one or more webpages corresponding to the retail stores.

Subsequently, the data processing arrangement may be operable to analyze the gathered information to determine at least one of:

(a) one or more products that have a high demand in a given geographical location, and/or

(b) one or more geographical locations where there is a high demand for a given product.

In this manner, the data processing arrangement may be operable to correlate inventories of the retail stores with location-based demands of the online searches.

It should be noted that the term “webpage” may refer to typical Internet-based webpages and websites as well as mobile-based webpages and websites, throughout the present disclosure.

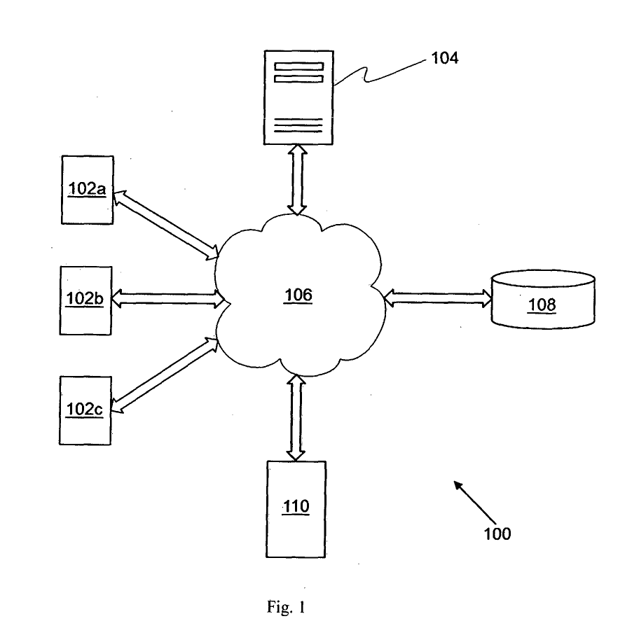

Referring now to the drawings, particularly by their reference numbers, FIG. 1 is a schematic illustration of a system 100 for improving visibility of one or more webpages of one or more retail stores in online searches, in accordance with an embodiment of the present invention. The system 100 includes one or more client devices associated with the retail stores, depicted as a client device 102a, a client device 102b and a client device 102c in FIG. 1 (hereinafter collectively referred to as client devices 102). The system 100 also includes a data processing arrangement 104, a communication network 106, and one or more databases, depicted as a database 108. Optionally, the system 100 may also include one or more managerial client devices, depicted as a managerial client device 110.

The system 100 may be implemented in various ways, depending on various possible scenarios. In one example scenario, the system 100 may be implemented by way of a spatially collocated arrangement of the data processing arrangement 104 and the database 108. In another example scenario, the system 100 may be implemented by way of a spatially distributed arrangement of the data processing arrangement 104 and the database 108 coupled mutually in communication via the communication network 106. In yet another example scenario, the data processing arrangement 104 and the database 108 may be implemented via cloud computing services.

The data processing arrangement 104 may, for example, be implemented by way of one or more servers between which various functionalities of the data processing arrangement 104 may be distributed.

The data processing arrangement 104 is coupled in communication with the client devices 102 and the managerial client device 110 via the communication network 106. The communication network 106 can be a collection of individual networks, interconnected with each other and functioning as a single large network. Examples of such individual networks include, but are not limited to, Local Area Networks (LANs), Wide Area Networks (WANs), telephone networks and the Internet. Further, the communication network 106 may be wireless, wired, or a combination thereof.

Examples of the client devices 102 and the managerial client device 110 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), Handheld PCs, and laptop computers.

Users use the client devices 102 to provide the data processing arrangement 104 with inputs for creating and/or updating the webpages of the retail stores. These inputs may be provided in a form of one or more messages that may, for example, include information pertaining to content to be displayed on these webpages. Upon receiving the inputs, the data processing arrangement 104 creates and/or updates the webpages of the retail stores.

For illustration purposes only, let us consider an example scenario in which a given user is responsible for providing inputs for creating and/or updating a given webpage of a given retail store, and the client device 102a is associated with the given retail store. The given user may, for example, be a store manager of the given retail store. Let us also consider, for example, that the given user uses the client device 102a to send one or more store-specific messages to the data processing arrangement 104.

For example, the store-specific messages may include information pertaining to at least one of: a name of the given retail store, a geographical location of the given retail store, an address of the given retail store, a phone number of the given retail store, an email address of the given retail store, timings of the given retail store, one or more businesses of the given retail store, one or more user-specified keywords for the given webpage, one or more photographs of the given retail store, directions within a map, one or more products offered by the given retail store, prices of one or more products, one or more deals provided by the given retail store, a marketing campaign occurring in the given retail store, a discount campaign occurring in the given retail store, one or more status updates, and/or one or more tips that may be of interest to visitors.

The Yore-specific messages may, for example, be sent in a form of at least one of: Short Messaging Service (SMS) messages, Multimedia Messaging Service (MMS) messages, Enhanced Messaging Service (EMS) messages, eXtended Messaging Service (XMS) messages, or electronic mails (emails). Accordingly, the store-specific messages may be sent in the form of a text, an image, an audio clip and/or a video clip.

For example, in a case where the client device 102a is a mobile phone, the given user may send the store-specific messages in the form of SMS messages. In such a case, the data processing arrangement 104 may gather information pertaining to the given webpage, for example, by sending and receiving interactive SMS messages to and from the client device 102a.

Upon receiving the store-specific messages, the data processing arrangement 104 is operable to process the store-specific messages to create and/or update the given webpage of the given retail store. For this purpose, the data processing arrangement 104 may be operable to extract information pertaining to content to be displayed on the given webpage from these store-specific messages, and provide the extracted information in the given webpage of the given retail store.

Optionally, in the given webpage, some or all of the store-specific messages may be provided with associated timestamps indicative of a time when the given user sent these store-specific messages. Beneficially, such timestamps may be provided with one or more of the store-specific messages pertaining to at least one of: one or more deals provided by the given retail store, a marketing campaign occurring in the given retail store, and/or a discount campaign occurring in the given retail store. This may help visitors find latest information provided on the given webpage.

Accordingly, the data processing arrangement 104 is operable to create and/or update the given webpage dynamically, as and when new store-specific messages are received by the data processing arrangement 104. Beneficially, the given webpage may be created and/or updated on a real-time basis. Alternatively, the given webpage may be created and/or updated on a periodic basis.

Additionally, the data processing arrangement 104 is operable to parse the store-specific messages to extract one or more keywords pertaining to the given webpage. Beneficially, the store-specific messages may be parsed semantically.

Thereafter, the data processing arrangement 104 is operable to provide the keywords in the given webpage of the given retail store. For example, the keywords may be provided in content and/or metadata of the given webpage of the given retail store. This may help structure the content and/or the metadata of the given webpage in a relevant manner, so that web crawlers used by online search engines may be able to find the given webpage. This enables keyword-based searching of the given webpage in the online searches, and in turn, improves visibility of the given webpage in the online searches. This may also help visitors find information that is relevant to their online searches.

Moreover, the data processing arrangement 104 may be operable to identify the geographical location of the given retail store. In accordance with an embodiment of the present invention, the geographical location of the given retail store may be identified based on at least one of the keywords extracted from the store-specific messages.

In accordance with another embodiment of the present invention, the geographical location of the client device 102a may be considered as the geographical location of the given retail store. The geographical location of the client device 102a may, for example, be determined from information pertaining to an Internet Service Provider (ISP) or a Telecommunications Service Provider (TSP) of the client device 102a. In one example, the geographical location of the client device 102a may be determined from an Internet Protocol (IP) address of the client device 102a. In another example, the geographical location of the client device 102a may be provided by a Global Positioning System (GPS) sensor of the client device 102a.

Beneficially, information pertaining to the geographical location of the given retail store may be provided in the given webpage of the given retail store. Such information may, for example, include geographic coordinates, such as latitude and longitude, of the geographical location of the given retail store. This may enable location-based searching of the given webpage of the given retail store in the online searches. This may further improve the visibility of the given webpage in the online searches.

Additionally, the data processing arrangement 104 may be operable to store the store-specific messages in the database 108. Beneficially, the store-specific messages may be stored with associated timestamps. The data processing arrangement 104 may also be operable to store the keywords along with the store-specific messages in the database 108.

Moreover, the data processing arrangement 104 may be operable to classify the store-specific messages into a plurality of classifications depending on similarities between the keywords and/or time periods between which the store-specific messages were received by the data processing arrangement 104. Information pertaining to the classifications of the store-specific messages may be stored in the database 108, and may be accessed from the database 108, as and when required. For example, when a visitor of the given webpage chooses to view store-specific messages pertaining to a particular classification, the data processing arrangement 104 may access the information pertaining to the classifications to display one or more store-specific messages classified into that particular classification.

Moreover, the data processing arrangement 104 may be operable to analyze keywords extracted from most recent store-specific messages to identify an entity to which the most recent store-specific messages pertain. The most recent store-specific messages may, for example, include a plurality of store-specific messages received from the client device 102a within a predefined time period. The predefined time period may be either user-defined or system-defined by default.

Subsequently, the data processing arrangement 104 may be operable to select a category related to the entity from a plurality of predefined categories. The predefined categories may be either user-defined or system-defined by default.

The data processing arrangement 104 may then be operable to update one or more existing features of the given webpage and/or add one or more new features to the given webpage, based upon the selected category.

Let us consider, for example, that most recent store-specific messages sent by a store manager of a particular retail store have been identified to be related to “food”, “home delivery” and/or “take away”. Accordingly, the data processing arrangement 104 may identify that particular retail store as a restaurant, and select a suitable category from amongst the predefined categories.

The data processing arrangement 104 may then update one or more existing features of a respective webpage of that particular retail store. For example, a background image of the webpage may be updated, so as to correspond to a theme of the restaurant. This may improve visible appearance of the webpage, and highlight the category to which the entity may belong. In addition, the store manager does not have to wait for reviews from third-parties to let visitors learn about the category to which the entity may belong.

Additionally, the data processing arrangement 104 may add one or more new features to the webpage. For example, a “Reserve a table” feature may be added to the webpage, so as to allow the visitors to reserve a table at the restaurant.

In this manner, the data processing arrangement 104 may be operable to update the existing features and/or add the new features dynamically and automatically, based on the most recent store-specific messages. This may be particularly useful for retail stores whose business may change with time.

Furthermore, a managerial user may be responsible for providing inputs for updating some or all of the webpages of the retail stores. The managerial user may, for example, be a regional manager of a brand with which the retail stores may be associated, or a brand manager of the brand. Let us consider, for example, that the managerial user uses the managerial client device 110 to send one or more messages to the data processing arrangement 104. These messages may, for example, mutually pertain to some or all of the retail stores.

The data processing arrangement 104 may be operable to receive the messages, and may then be operable to analyze these messages to update one or more webpages corresponding to these retail stores, as described earlier.

Optionally, the system 100 may be operable to integrate webpages of retail stores associated with a particular brand with an existing website of that particular brand.

Additionally or alternatively, these webpages may be linked with the existing website of that particular brand via one or more plug-ins that may be provided on the existing website of that particular brand. For example, clicking on a plug-in provided on the existing website of that particular brand may open a webpage displaying latest information that may be of interest to visitors.

Moreover, the data processing arrangement 104 may be operable to identify a current geographical location of a visitor visiting one of the webpages of the retail stores associated with the particular brand, and suggest at least one of the retail stores that is in a proximity of the current geographical location of the visitor.

Moreover, when a visitor visits a particular webpage, the data processing arrangement 104 may be operable to identify one or more search parameters associated with the visitor. The search parameters may, for example, include at least one of: a search query from whose search results the visitor landed on that particular webpage, a search engine on which the visitor performed an online search using the search query, a geographical location of the visitor, and/or a geographical location of interest to the visitor.

It may be noted here that the geographical location of the visitor may not always be the geographical location of interest to the visitor. The geographical location of the visitor may be determined from an IP address of a computing device from which the visitor performed the online search and/or by a GPS sensor of the computing device, while the geographical location of interest to the visitor may be identified from a name of a place provided in the search query itself. For example, a visitor residing in Delhi may be interested in searching for handicraft items in Hyderabad, and may have used “handicraft in Hyderabad” as a search query.

The data processing arrangement 104 may be operable to analyze the search parameters to determine products in which the visitor was interested. The data processing arrangement 104 may then be operable to send one or more notifications to a store manager of a retail store associated with that particular webpage. The notifications may, for example, be sent to a client device of the store manager.

Beneficially, the notifications may be sent on a real-time basis. Consequently, the system 100 may be operable to notify the store manager about recent visits made to the particular webpage.

Optionally, the system 100 may be operable to recommend the store manager to update the particular webpage with additional information about the products in which the visitor was interested. For this purpose, the store manager may send one or more store-specific messages pertaining to the products from his/her client device to the data processing arrangement 104. In this way, the system 100 enables the store manager to keep the particular webpage up-to-date.

Additionally, the data processing arrangement 104 may be provided with information pertaining to inventories of the retail stores, for example, during creating and/or updating of the webpages of the retail stores. The information pertaining to the inventories of the retail stores may be stored in the database 108.

Furthermore, the data processing arrangement 104 may be operable to access search logs maintained by one or more servers (not shown in FIG. 1) of one or more online search engines, such as Google (Google is a registered trademark). An example entry in such search logs may, for example, include information pertaining to at least one of a search query used by a visitor to perform a particular online search, a search result (i.e., a webpage) of that particular online search selected by the visitor, a geographical location of the visitor, and/or a geographical location of interest to the visitor. As described earlier, the geographical location of the visitor may, for example, have been determined from an IP address of a computing device from which the visitor performed the particular online search and/or by a GPS sensor of the computing device.

The data processing arrangement 104 may be operable to analyze the search logs to gather information pertaining to at least one of:

(a) one or more products searched for in the online searches, and/or

(b) geographical locations of one or more visitors who performed the online searches to visit one or more of the webpages corresponding to the retail stores.

For example, a product searched for in the particular online search may be identified from a name of the product provided in the search query itself. In some cases, a geographical location of interest to the visitor may be identified from a name of a place provided in the search query itself.

Thereafter, the data processing arrangement 104 may be operable to analyze the gathered information to determine one or more products that have a high demand in one or more geographical locations or a geographical region encompassing these geographical locations. Accordingly, the data processing arrangement 104 may be operable to correlate the inventories of the retail stores with location-based demands of the online searches.

The system 100 may then be operable to provide results of such analyses and/or correlations to store managers of the retail stores. These results may be indicative of trends and patterns in demands of the visitors. Beneficially, the results may be provided in a form of one or more reports, which may be sent periodically to the store managers.

In this manner, the system 100 enables the store managers to manage the inventories of their respective retail stores depending on the location-based demands of the online searches. For example, a store manager of a retail store in a particular geographical location may check whether or not a particular product that has a high demand in that particular geographical location is available in an inventory of the retail store. Accordingly, the store manager may manage the inventory of the retail store, such that the particular product may be made available in the inventory to meet a location-based demand of that particular product.

Additionally, the store manager may send one or more store-specific messages pertaining to upcoming and/or ongoing deals and/or discounts on the particular product available in the retail store, from his/her client device to the data processing arrangement 104. The data processing arrangement 104 may then update a respective webpage of the retail store with the store-specific messages sent by the store manager. In this manner, the system 100 assists the store manager in updating the webpage, thereby providing information about the upcoming and/or ongoing deals and/or discounts available in the retail store. This may consequently attract visitors interested in purchasing that particular product to the webpage of the retail store. This may also help the visitors to relate directly to the retail store.

Moreover, the data processing arrangement 104 may be operable to analyze the gathered information to determine one or more geographical locations where there is a high demand for a given product. In this manner, the system 100 enables brand managers to identify one or more geographical locations where businesses of their brands are likely to be profitable. For example, a brand manager may consider a particular geographical location for expanding a business of his/her brand by opening new retail stores in that particular geographical location.

It should be noted here that the implementation of the system 100 is not limited to a specific number of client devices, managerial client devices, data processing arrangements, communication networks, and databases. FIG. 1 is merely an example, which should not unduly limit the scope of the claims herein. One of ordinary skill in the art would recognize many variations, alternatives, and modifications of embodiments herein.

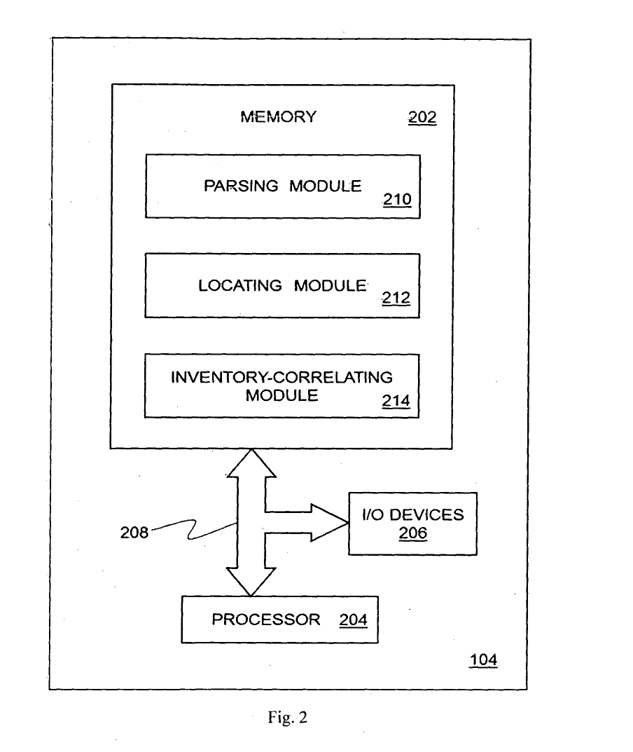

FIG. 2 is a schematic illustration of various components in an example implementation of the data processing arrangement 104, in accordance with an embodiment of the present invention. The data processing arrangement 104 includes, but is not limited to, a memory 202, a processor 204, Input/Output (I/O) devices 206, and a system bus 208 that operatively couples various components including the memory 202 and the processor 204. The memory 202 stores a parsing module 210 and a locating module 212. Optionally, the memory 202 may store an inventory-correlating module 214.

When executed on the processor 204, the parsing module 210 is operable to parse store-specific messages received from the client devices 102, to extract keywords pertaining to respective webpages of the retail stores. The keywords so extracted may then be provided in the respective webpages of the retail stores, as described earlier. This enables keyword-based searching of these webpages in the online searches, and in turn, improves visibility of these webpages in the online searches.

Beneficially, the parsing module 210 may be operable to parse the store-specific messages semantically, thereby enabling semantic search of the webpages.

When executed on the processor 204, the locating module 212 is operable to identify geographical locations of the retail stores. In accordance with an embodiment of the present invention, the geographical locations of the retail stores may be identified based on at least one of the keywords extracted from the store-specific messages.

In accordance with another embodiment of the present invention, the geographical locations of the client devices 102 may be considered as the geographical locations of the retail stores with which these client devices 102 are associated. The geographical locations of the client devices 102 may, for example, be determined from information pertaining to ISPs or TSPs of the client devices 102, as described earlier. In one example, a geographical location of a particular client device may be determined from an IP address of that particular client device. In another example, the geographical location of the particular client device may be provided by a GPS sensor of that particular client device.

Beneficially, information pertaining to the -geographical locations of the retail stores may be provided in the respective webpages of these retail stores, as described earlier. This may enable location-based searching of these webpages in the online searches. This may further improve the visibility of these webpages in the online searches.

When executed on the processor 204, the inventory-correlating module 214 is operable to access the search logs maintained by the online search engines. The inventory-correlating module 214 is operable to analyze the search logs to gather information pertaining to at least one of:

(a) one or more products searched for in the online searches, and/or

(b) geographical locations of one or more visitors who performed the online searches to visit one or more of the webpages corresponding to the retail stores.

Thereafter, the inventory-correlating module 214 is operable to analyze the gathered information to determine one or more products that have a high demand in the geographical locations of the retail stores. Accordingly, the inventory-correlating module 214 is operable to correlate the inventories of the retail stores with location-based demands of the online searches, as described earlier.

In accordance with an embodiment of the present invention, the data processing arrangement 104 is implemented spatially within one or more servers. Beneficially, the data processing arrangement 104 may be implemented via computing hardware that is operable to execute one or more software products recorded on non-transitory machine-readable data storage media.

FIG. 2 is merely an example, which should not unduly limit the scope of the claims herein. It is to be understood that the specific designation for the data processing arrangement 104 is for the convenience of reader and is not to be construed as limiting the data processing arrangement 104 to specific numbers, types, or arrangements of modules and/or components of the data processing arrangement 104. One of ordinary skill in the art would recognize many variations, alternatives, and modifications of embodiments of the present invention.

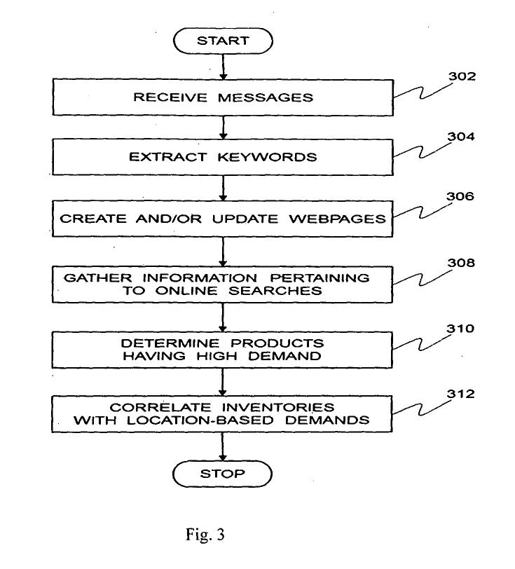

FIG. 3 is an illustration of steps of a method of operating the system 100, in accordance with an embodiment of the present invention. The method is depicted as a collection of steps in a logical flow diagram, which represents a sequence of steps that can be implemented in hardware, software, or a combination thereof.

At a step 302, store-specific messages are received from the client devices 102 associated with the retail stores, as described earlier.

Next, at a step 304, the store-specific messages received at the step 302 are parsed to extract keywords pertaining to respective webpages of the retail stores. The step 304 may, for example, be performed using semantic parsing.

Subsequently, at a step 306, the store-specific messages are processed to create and/or update the respective webpages of the retail stores. In accordance with the step 306, information pertaining to the content to be displayed on the webpages is extracted from the store-specific messages.

Moreover, the keywords extracted at the step 304 are provided in the respective webpages of the retail stores. For example, the, keywords may be provided in content and/or metadata of these webpages. This enables keyword-based searching of the webpages of the retail stores in the online searches, and in turn, improves visibility of these webpages in the online searches.

The step 306 may be performed either on a real-time basis or on a periodic basis.

When new store-specific messages are sent from the client devices 102, the steps 302, 304 and 306 are repeated. In this manner, the webpages are created and/or updated dynamically, as and when required.

Additionally, the method may include a step at which the geographical locations of the retail stores may be identified, as described earlier. Beneficially, information pertaining to the geographical locations of the retail stores may be provided in the respective webpages of the retail stores. This may enable location-based searching of these webpages in the online searches, and may further improve the visibility of these webpages in the online searches.

Furthermore, at a step 308, the search logs of the online search engines are analyzed to gather information pertaining to at least one of:

(a) one or more products searched for in the online searches, and/or

(b) geographical locations of one or more visitors who performed the online searches to visit one or more of the webpages corresponding to the retail stores.

Subsequently, at a step 310, the information gathered at the step 308 is analyzed to determine one or more products that have a high demand in the geographical locations of the retail stores.

Thereafter, at a step 312, the inventories of the retail -stores are -correlated with location-based demands of the online searches. This enables store managers to manage the inventories of their respective retail stores depending on the location-based demands, as described earlier.

It should be noted here that the steps 302 to 312 are only illustrative and other alternatives can also be provided where one or more steps are added, one or more steps are removed, or one or more steps are provided in a different sequence without departing from the scope of the claims herein.

Embodiments of the present invention can be used for various purposes, including, though not limited to, enabling users to create and/or update webpages of their respective retail stores to provide latest information on the webpages in real time, thereby improving visibility of the webpages in online searches; helping visitors find information that is relevant to their online searches; enabling store managers to manage inventories of their respective retail stores depending on location-based demands of the online searches; and/or enabling brand managers to identify one or more geographical locations where businesses of their brands are likely to be profitable.

Modifications to embodiments of the present invention described in the foregoing are possible without departing from the scope of the present invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

What is claimed is:

1. A system for improving visibility of one or more webpages of one or more retail stores in online searches, the system comprising one or more client devices associated with the one or more retail stores, and a data processing arrangement coupled in communication with the one or more client devices, wherein
the data processing arrangement is operable to receive one or more store-specific messages from a given client device from amongst the one or more client devices associated with a given retail store from amongst the one or more retail stores, wherefrom the data processing arrangement is operable to process the one or more store-specific messages to create and/or update a given webpage of the given retail store,
further wherein the data processing arrangement is operable to parse the one or more store-specific messages to extract one or more keywords, and is operable to provide the one or more keywords in the given webpage, thereby enabling keyword-based searching of the given webpage of the given retail store in the online searches.

2. The system as claimed in claim 1, wherein at least one of the one or more keywords pertains to a geographical location of the given retail store, thereby enabling location-based searching of the given webpage of the given retail store in the online searches.

3. The system as claimed in claim 1, wherein the data processing arrangement is operable to classify the one or more store-specific messages into a plurality of classifications depending on similarities between the one or more keywords and/or time periods between which the one or more store-specific messages were received.

4. The system as claimed in claim 1, wherein the data processing arrangement is operable to update one or more existing features of the given webpage and/or add one or more new features to the given webpage, based on most recent store-specific messages.

5. The system as claimed in claim 1, wherein the data processing arrangement is operable to send one or more notifications to the given client device about recent visits made to the given webpage.

6. The system as claimed in claim 1, wherein the given webpage is created and/or updated on a real-time basis.

7. The system as claimed in claim 1 further comprising a managerial client device coupled in communication with the data processing arrangement, wherein the data processing arrangement is operable to receive from the managerial client device one or more messages mutually pertaining to the one or more retail stores, wherefrom the data processing arrangement is operable to analyze the one or more messages to update the one or more webpages corresponding to the one or more retail stores.

8. The system as claimed in claim 1 wherein the data processing arrangement is operable to gather information pertaining to at least one of: products searched for in the online searches, and/or geographical locations of visitors who performed the online searches to visit the one or more webpages corresponding to the one or more retail stores.

9. The system as claimed in claim 8, wherein the data processing arrangement is further operable to analyze the gathered information to determine at least one of: one or more products that have a high demand in a given geographical location and/or one or more geographical locations where there is a high demand for a given product.

10. The system as claimed in claim 8, wherein the data processing arrangement is further operable to correlate inventories of the one or more retail stores with location-based demands of the online searches.
